(19) United States
(12) Patent Application Publication
(10) Pub. No.: US 2006/0184708 A1
(43) Pub. Date: Aug. 17, 2006

(54) Host controller device and method

(76) Inventors: Peter T. Sleeman, Horndean (GB); Richard B. H. Prescott, Bishop Waltham (GB)

Correspondence Address: Don W. Bulson, Esq.;Renner, Otto, Boisselle & Sklar, P.L.L., 19th Floor, 1621 Euclid Ave., Cleveland, OH, 44115, US

(21) Appl. No.: 11/332,904

(22) Filed: Jan. 17, 2006

(30) Foreign Application Priority Data
Feb. 14, 2005 (GB) GB 0503030.9

(51) Int. Cl. G06F 13/20

(52) U.S. Cl. 710/313

(57) ABSTRACT

A host controller (400) for interfacing one or more electronic devices (410, 411) to a packet-based timeshared bus, such as a system bus (402) or a universal serial bus (409), is disclosed. The host controller (400) comprises a first memory device (413) storing a sequence of predetermined transaction descriptors (TD) and a second memory device (405, 406) for storing payload data transmitted over a bus (402, 409). A transaction sequencer (407) is also provided that is operable cyclically to execute transactions defined by the transaction descriptors (TD) stored in the first memory device (413) so as to transmit or receive payload data in the second memory device (405, 406). By cycling through a predetermined set of transaction descriptors (TD) without the need to initially compile an operational set of transaction descriptors to process, the host controller (400) can operate as a simple slave device on a wide variety of existing buses. As an additional benefit, the host controller (400) does not require the use of bus mastering or direct memory (DMA) techniques, which leads to the provision of a simplified and inexpensive device.

### FIELD OF THE INVENTION

The present invention relates to a host controller device and method. In particular it relates to a host controller device and method for interfacing electronic devices to a packet-based timeshare bus. The universal serial bus (USB) is one example of such a packet-based timeshare bus with which devices and methods according to the present invention may be used.

### BACKGROUND OF THE INVENTION

Various types of bus are known for connecting electronic components, such as processors, memory, controllers, peripherals etc. for the purposes of communication and sharing resources, data, etc. In order to connect such an electronic component to a bus a host controller is provided. The host controller acts as an interface between the electronic component and the bus, and handles the timing and formatting of any data that is to be transferred.

Many different types of bus exist. One generic type uses packet-based time sharing of bus bandwidth. As mentioned above, the USB is one example of such a packet-based timeshare bus. The USB is a well-established means for attaching peripheral devices and circuits to host devices. The USB standard is described in detail in the publicly available USB Specification Rev2.0 document.

FIG. 1 shows a conventional USB host controller and host system. In order to connect one or more electronic devices 101, such as peripherals, to a host electronic device, such as a computer 108, a USB host controller device 103 is used by a host processor 102 to manage the USB protocol and to generate bus transactions on USB connections 107. Commonly, a USB host controller device 103 will comply with one of several industry standards, namely the UHCI (Universal Host Controller Interface), the OHCI (Open Host Controller Interface) or the EHCI (Enhanced Host Controller Interface). These standards define how the host controller 103 will behave from the host processor's perspective, such as the registers it will expose on a system bus 106, how the USB transfers are scheduled, and how the host controller 103 will notify the host electronic device 108 of changes of state (e.g. device connections, transmission errors etc). All three standards assume that the method of scheduling transfers on the USB is the same, and this method will now be summarised.

In order for an OHCI, UHCI or EHCI host controller 103 to manage data flow in both directions between the electronic devices 101 and the host electronic device 108, the host processor 102 executes a USB software driver 105. This driver 105 creates a transfer list 110 in a system memory 104 of the host electronic device 108 which is accessible via the system bus 106 to both the host processor 102 and the USB host controller 103 in an autonomous way, i.e. the host controller 103 can read and write the transfer list 110 without needing intervention from the host processor 102 or device driver 105.

The device driver 105 is responsible for managing the timely and orderly exchange of data with the electronic devices 101 by correctly managing the transfer list 110, with the USB host controller 103 interpreting this transfer list 110 in an automatic way using an internal logic sequencer 111 in order to create bus traffic on the USB 107. This can be visualised as using the main system memory 104 as a shared resource between the device driver 105 and the USB host controller 103, allowing the former to set up the transfers required and the latter to autonomously execute them. For this process to work, a direct bus access method and memory arbiter (not shown) is needed to manage the time-shared accesses of the transfer list 110 by the host processor 102, device driver 105 and the USB host controller 103. This direct bus access method is commonly either by bus mastering, where the USB host controller 103 gains exclusive use of the system bus 106 so allowing it to read and write to main system memory 104, or by Direct Memory Access (DMA) where the USB host controller 103 requests data indirectly from main system memory 104 via an autonomous DMA controller 109, without explicit host processor 102 intervention.

The bus mastering method does not require a separate bus controller because the mastering aspect is built into each device in the system that requires this capability.

Each device is itself a bus mastering controller using the bus mastering facility that is part of the fabric of the system bus 106.

Both the bus mastering method and the DMA method are well known in the art and have been used for many years.

The bus mastering and DMA access methods are advantageous in that they allow the device driver 105 to schedule data transfers over the USB 107 without constant re-configuration of the USB host controller 103. The host controller 103 essentially provides a hard-wired logic sequencer that cycles though the transfer list 110. This also allows the USB host controller 103 to be fabricated cheaply as it does not need its own temporary storage for transfer lists 110 and payload data. Such a USB host controller 103 is flexible, being able to deal with any size of transfer list 110 that can be accommodated by the main host system memory 104. For these reasons, this type of USB host controller 103 has been a great success and is currently used in almost all personal computers.

Although useful, there exists a class of host processors that do not have the ability to perform bus mastering or DMA, and which as a consequence cannot use the OHCI/UHCI/EHCI type host controller 103. This class of device commonly comprises micro-processors or micro-controllers that are designed for use in smaller lower-powered host systems, and which do not therefore need the complexity of an external bus using such access methods.

Additionally, there are also expansion buses that cannot offer autonomous access methods to main system memory. For example, the 16-Bit PCMCIA and Compact Flash buses are both slave-only busses, which offer neither a bus mastering nor a DMA option.

It would therefore be desirable to have an architecture for a USB host controller that provides simpler bus access methods, like programmed I/O and memory mapped registers. In this way, the USB host controller could become a slave-only device, relying on a host processor and a device driver to copy the transfer lists and payload data into a memory implemented within the USB host controller itself.

FIG. 2 shows a conventional embedded USB host controller. A host controller 200 comprises a bank of memory 205 in the host controller 200 that is written to and read by a host device driver 201 executing on a host processor 211 in a host system 212. Using a system bus 202 for communications, the memory 205 is used for storage of a transfer list 203 and its associated payload data 204.

WO 2004/102406 [1] discloses such a host controller 200. The memory 205 within the host controller 200 is used to store a “plurality of transfer-based transfer descriptors”. These transfer descriptors are the same in nature as those used in the OHCI/UHCI/EHCI architecture, that would have been created in the system memory 104 as the transfer list 110 shown in FIG. 1 above.

The transfer descriptors describe the characteristics of the transfer required and also the payload data 204 to be communicated. The logical organisation of the host controller 200 and storage memory 205 may be such that the transfer descriptors and payload data 204 are all presented together in one contiguous block, or alternatively the transfer descriptors may be held in one range of addresses with the payload data 204 held in another range of addresses with the transfer descriptors having an explicit address link 206 to the payload data 204. Using this technique, the USB host controller 200 can read the transfer list 203 from memory 205 and execute the list 203 autonomously using a hardware transfer sequencer 207. This causes USB traffic to appear on the USB connections 209, and a subsequent updating of the transfer list 203 to reflect the outcome of the transfers and to present any payload data 204 in the memory 205 that may have resulted from a data transfer from a peripheral 210 to the host system 212. Typically, the transfer list 203 is of a “linked list” type, that is well known to those skilled in the art. This has the advantage of improved flexibility, since the linked-list is almost limitlessly extendable and can be scanned and created easily by software.

WO 2004/102406 discloses a device in which the internal execution by the USB host controller 200 of the USB transfer list 203 is similar to the classic OHCI/UHCI/EHCI schemes, with the key difference being that the transfer list 203 is stored locally to the host controller 200, thereby removing the need for bus mastering or DMA access methods. A host device driver 201 is adapted in this case so that rather than creating the transfer list 203 in main system memory 213, it instead creates it in the local memory 205 of the USB host controller 200. Such a USB host controller 200 uses a memory architecture such that an arbiter 208 in the host controller 200 enables shared access to the local transfer list 203 and payload memory 205. Typically the memory architecture used will be an arbiter 208 with a single ported RAM or a dual ported RAM.

FIG. 3 shows examples of USB transfers and transactions, and provides a pictorial representation of the protocol used on the USB. It is important at this point in the description to highlight a key item of terminology regarding “transfers” and “transactions” where USB is concerned. A “transfer” 300 is a complete movement of a notional unit of data on a USB. A “transaction” 301 is a lower level part of a “transfer” and consists of protocol activities such as synchronisation 303, packet identification 304, data framing 305, check-summing 306 and handshaking 307.

By way of example, if a unit of data were split into two parts 302 for transmission over the USB, each part would be moved using a transaction 301 on the USB, and would form part of the overall transfer 300. The data unit splitting may occur due to scheduling reasons (the USB is time shared with all other electronic devices, such as peripherals) or because the overall data unit is too large for transmission in one piece. In the limiting case, a very simple transfer could reduce to the point where it happens using just one bus transaction. More usually however, a transfer consists of several transactions on the USB.

Conventional embedded type USB host controllers (including those described in WO2004/102406 [1] and also US 2002/0116565 [2] deal with transfer lists rather than transaction lists, that is, the host device driver creates a list of these high level transfers for execution by the USB host controller. As such, these host controllers are all “transfer-driven”, wherein the host controller will execute a complete transfer descriptor by breaking them into discrete bus transactions and notifying the host device driver when the entire transfer is completed. By its nature, executing a transfer is more complex than executing a single transaction, the former typically being made up of several of the latter. To autonomously sequence a transfer is therefore intrinsically more complex than autonomously sequencing a transaction.

As previously mentioned, one example method of organising a transfer list is to use a linked-list. This type of structure is easily scanned by software, but it does not lend itself to autonomous scanning by simple hardware. A linked-list requires a random access memory capability and so does not work naturally using a FIFO type memory architecture. A linked-list also tends to make extensive use of memory pointers, these pointers often being lengthy (perhaps 12 bits or greater to be able to address the controller's memory space), and each pointer requiring arithmetic manipulation to allow traversal of the list. This does not lend itself to compact, low power logic because hardware arithmetic operations tend to consume a significant amount of logic resource.

The USB host controllers are described in WO 2004/102406 [1] and US 2002/0116565 [2] thus use a host processor in order to provide a host controller with a list of descriptors that describe the movement of data units on the bus. Such a transaction may be complex involving the multiple transactions, e.g. the transmission of sub-units of data, that together comprise a complete data transfer operation.

It will thus be understood that conventional host controllers are relatively complex devices which are relatively expensive to design. Moreover, when designing a host controller to operate with a particular bus architecture, it is often difficult to ensure that the implementing logic is free of design faults or bugs due to the complexity of the host controller. Moreover, conventional host controllers are generally also physically relatively large and tend to consume significant amounts of power, which can make them unsuited to certain applications, particularly where portable devices are required.

### SUMMARY OF THE INVENTION

According to a first aspect of the present invention, there is provided a host controller for interfacing one or more electronic devices to at least one packet-based timeshared bus. The host controller comprises a first memory device storing a sequence of transaction descriptors and a second memory device for storing payload data transmitted over at least one packet-based timeshare bus. The transaction descriptors may be predetermined or configurable as desired. The host controller also comprises a transaction sequencer that is operable cyclically to execute transactions defined by the transaction descriptors stored in the first memory device so as to act on payload data in respect of the second memory device, typically to transmit payload data from, or receive payload data into, the second memory device.

The host controller is a transaction based device that does not require an external electronic device to provide it with data relating to complete data transfers in a unitary way. Specifically, a linked-list approach is not required. By repeatedly executing a simple list of transactions, a simplified host controller is thus provided. Such a controller can be made smaller and more power efficient than existing host controllers, and is also easier to design for connecting to a variety of standard bus architectures.

In various embodiments, the host controller comprises one or more first-in-first-out memory devices (FIFOs) for storing payload data. This is advantageous as it enables the host controller to be “data-driven” whereby data transfer can be initiated depending upon the fullness of the memory device. This further improves resource utilisation in devices including the host controller by enabling efficient block data moves at high speed to and from the FIFO(s), for example.

The host controller may include a transaction sequencer that is operable to identify transactions as being disabled and to skip the processing of such transactions. This allows a standard host controller to be manufactured that can be tailored to different bus architectures by selective software configuration of transactions that are to be executed during the cyclical execution process.

In various embodiments, the number of transaction descriptors stored in the host controller is chosen to be in the range 8 to 32. The choice of the number of predetermined transaction descriptors is a trade off which allows a host controller to be optimised for various applications in terms of the speed of cyclical operation and the manufacturing cost.

According to a second aspect of the present invention, there is provided a method for controlling data transfer between one or more electronic devices connected to at least one packet-based timeshared bus. The method comprises cyclically executing transactions respectively defined by a sequence of transaction descriptors stored in a host controller and storing the payload data in the host controller. The method may also comprise generating or collecting payload data for each transaction that is executed.

### BRIEF DESCRIPTION OF THE DRAWINGS

For a better understanding of the invention and to show how the same may be carried into effect reference is now made by way of example to the accompanying drawings in which:

FIG. 1 shows a conventional USB host controller and host system;

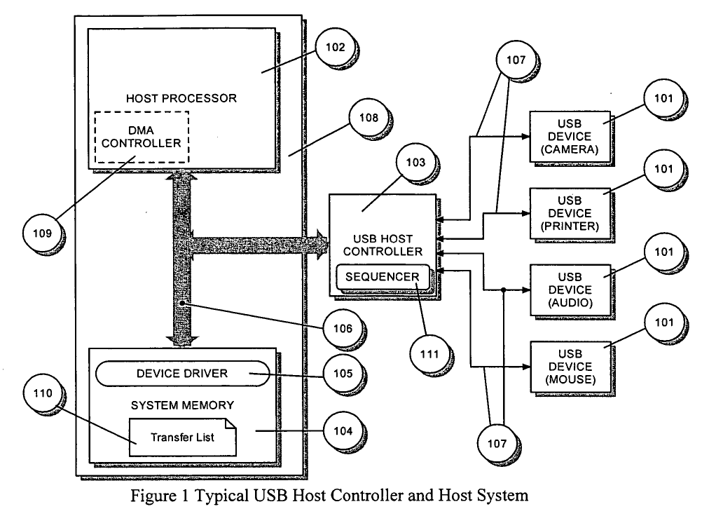

FIG. 2 shows a conventional embedded USB host controller;

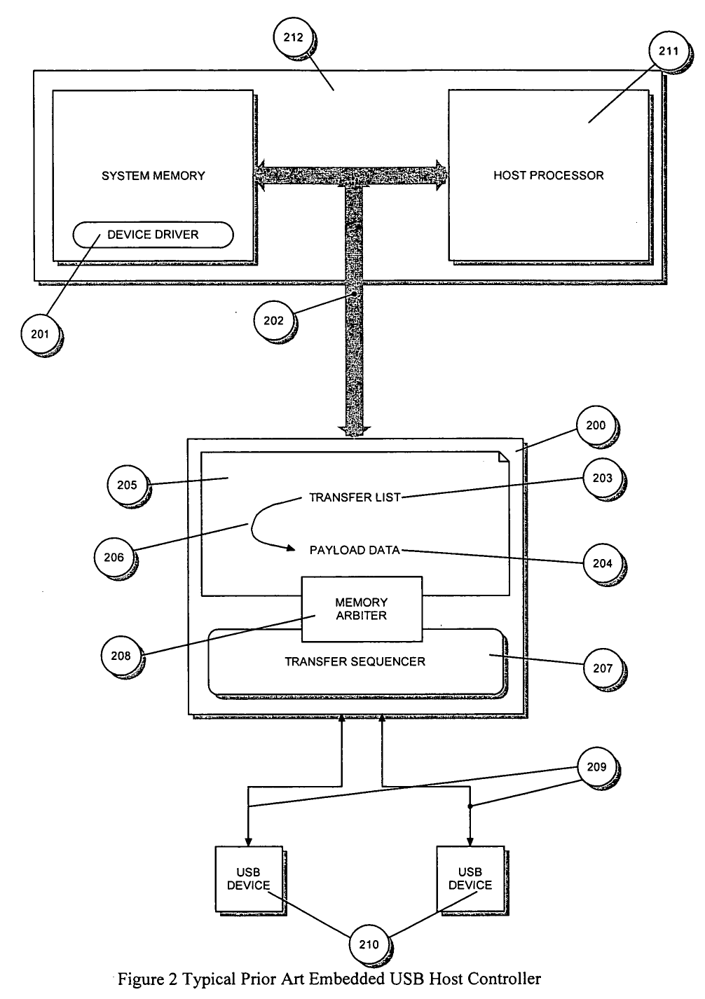

FIG. 3 shows examples of USB transfers and transactions;

FIG. 4 shows a host controller according to an embodiment of the present invention;

FIG. 5 shows transmit and receive FIFO data formats for use in the host controller of FIG. 4; and

FIG. 6 shows the host controller of FIG. 4 in greater detail.

### DETAILED DESCRIPTION

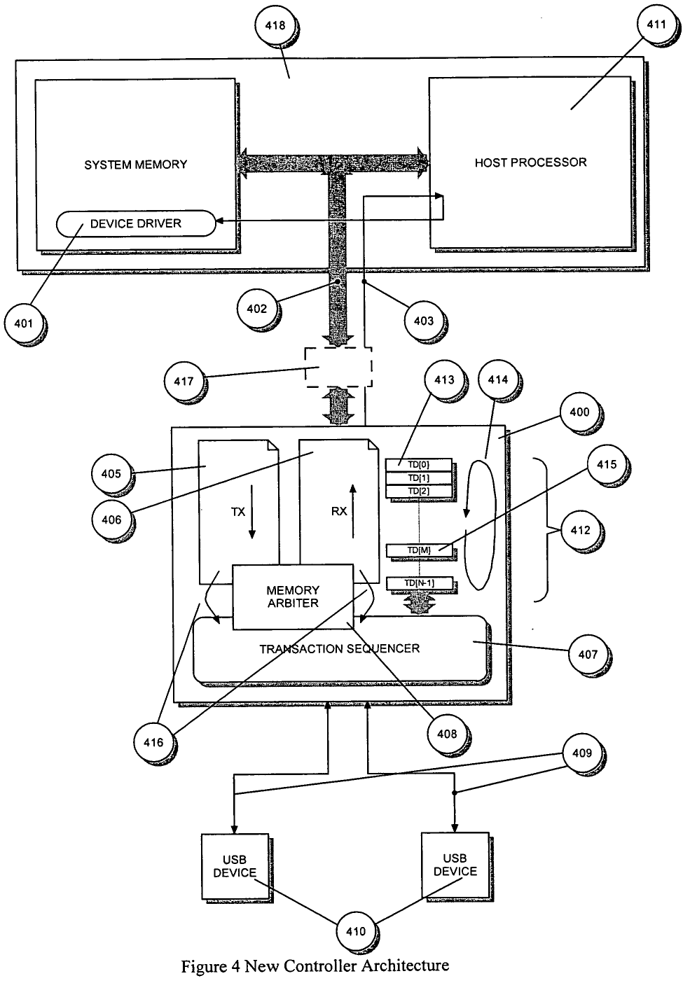

FIG. 4 shows a host controller according to an embodiment of the present invention.

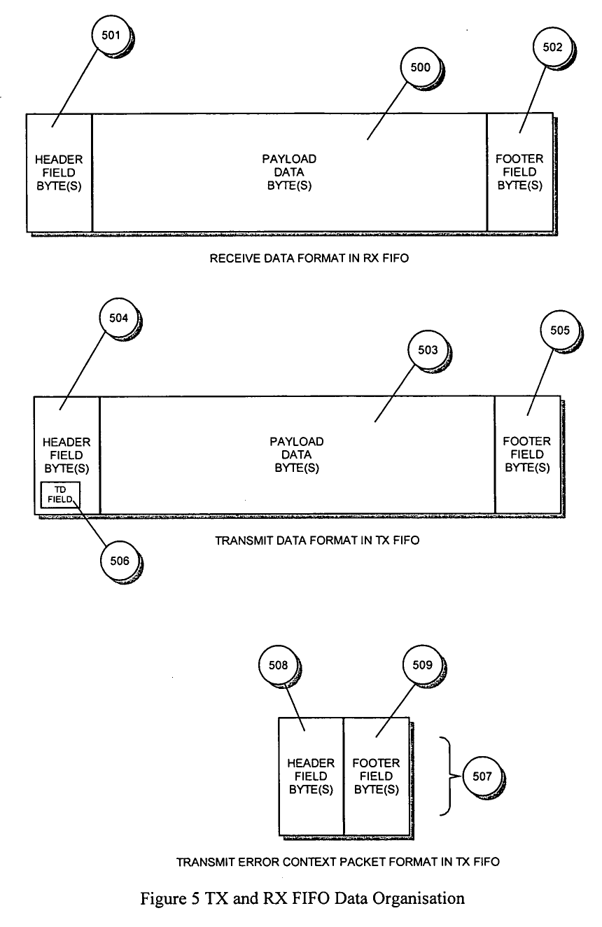

FIG. 5 shows transmit and receive FIFO data formats for use in the host controller embodiment shown in FIG. 4.

This embodiment relates to an architecture for a USB host controller that, rather than dealing with transfers, deals instead with transactions. This allows the host controller to be “data-driven” and allows the USB host controller to execute a repetitive list of transactions rather than interpreting a more complex list of transfers. This approach leads to a simpler host controller implementation, having advantages in cost, size and power consumption. The inherent reduction in complexity allows a device architecture with a simple repetitive transaction sequencer and a pair of payload data memories that can be filled and emptied by the host device driver on the basis of how full or empty is each memory.

A USB host controller 400 having a new architecture is shown. This has various advantages over conventional host controllers, being simpler to realise and hence smaller, cheaper and having lower power consumption. The host controller 400 uses a different technique from conventional host controllers allowing transactions and transfers to be scheduled on the USB, and further, allows the overall flow of bus activity between a device driver 401 in a host electronic device 418 and the USB host controller 400 to be driven by an amount of payload data waiting to be sent or that has been received.

The host controller 400 uses slave-only bus access methods. It is suitable for connection to any system bus or expansion bus 402 of a host processor 411 that can support programmed I/O and/or memory mapped register access methods. Advantageously, the bus 402 may support a means for implementing an asynchronous interrupt 403 request, allowing the host controller 400 to gain the host device driver's 401 attention for servicing and status change notifications. In the absence of such an interrupt, a polled method may be used by the device driver 401 to keep watch on the host controller 400 status.

The architecture of the host controller 400 moves more responsibility for the internal management of transfers to the host device driver 401, allowing a simplified architecture to be realised for the hardware transaction sequencer 407, so saving cost. In essence, the host device driver 401 becomes responsible not only for each USB transfer but also for the individual transactions that must occur to realise each transfer. The host device driver 401 also deals with aspects of the USB protocol such as retrying failed transactions, data sequencing, bandwidth utilisation at the transaction level etc.

The host controller 400 implements a simple transaction sequencer in hardware 407, although other implementations could be made in firmware, for example. A predetermined number 412 of transaction descriptors are stored in the host controller 400, in a first memory device 413, such as set of registers. In this way the transaction descriptors are kept separate from payload data held in a second memory device 405, 406 provided in the host controller 400.

An advantage of this is that the host controller 400 can easily cycle from one transaction descriptor to the next using a simple ring counter arrangement 414, whereas placing the transaction descriptors at arbitrary locations in a memory array would require a far more complex addressing scheme and would make it hard to create a deterministic scanning sequence for the transactions.

By having a predetermined number of transaction descriptors, a trade-off between the number of descriptors and the desired flexibility of the host controller 400 can be made. A small number of descriptors leads to simple and cheap logic and low list cycle time overhead, but means that the number of USB devices that can be easily serviced (i.e. without the device driver 401 needing to time-share the descriptors) is limited. Increasing the number of descriptors makes the transaction sequencer 407 require more hardware resources, adds directly to the time overhead of cycling the list, but allows for greater numbers of attached electronic devices 410 to each use their own dedicated descriptor(s). Implementations using 8 descriptors or fewer are suitable for simple host controllers where perhaps only one or two USB devices will ever be attached. Implementations with greater than 8 descriptors will allow more USB devices to be attached, which may be advantageous in some applications. A balance of between to 8 to 32 descriptors is currently envisaged for certain applications to offer a compromise.

The transaction sequencer 407 cycles around continuously 414, at a rate of one complete cycle every USB frame, checking each descriptor from 0 to N−1 (N being the number of descriptors implemented) in turn. The cyclical scan starts at 0 just after the USB Start Of Frame (a timing reference packet) has completed. Each descriptor is checked to see if it requires bus transactions or not. The sequence counts to N−1 and then pauses, waiting before returning to 0 again just after the next Start Of Frame. By the host device driver configuring and enabling or disabling each descriptor 413, this method allows a predictable sequence of USB bus transactions to occur, as will now be discussed.

Each transaction descriptor (TD) holds bit-fields that define the type of transaction (standard USB PID types like In, Out, Setup etc), and the target electronic device's 410 address, endpoint etc. So a transaction descriptor holds almost everything needed to conduct a transaction on the bus 402, 409, with two main omissions: i) there is no reference to where to find the payload data for an Out-transaction (transmit from host to device) and ii) there is no reference of where to put the payload data for an In-transaction (receive from device to host). Consequently, the transaction descriptor by itself is not enough to fully describe the transaction. This is where the data-driven nature of the disclosed host controller 400 is important.

Firstly, consider an In-transaction (data requested to flow from electronic device 410 to host electronic device 418).

In order to have the transaction sequencer 407 conduct an In-transaction repetitively every USB frame, one of the transaction descriptors, say the Mth one 415 (denoted as TD[M]), is configured by the host device driver 401 with the desired address, endpoint and code to denote an In-transaction.

Additionally, a bit in the TD indicates whether that TD must be executed or not by the transaction sequencer 407. If the TD is disabled, no bus transaction will be generated for TD[M] and the transaction sequencer 407 will skip on to TD[M+1]. If the TD is enabled, an In-transaction will be executed by the transaction sequencer 407 when TD[M] is reached by the transaction sequencer 407. The transaction sequencer 407 will be responsible for issuing the correct USB In PID (Packet Identifier) and will be ready to receive payload data from the addressed device 409 or may receive a no-acknowledge (a NAK) if there is no data available from the electronic device 410.

If data arrives, the transaction sequencer 407 will write it sequentially to a receive FIFO memory 406 in the host controller 400 (or a dual port RAM or single port RAM with an arbiter). With reference to FIG. 5, the payload data 500 will be pre-fixed by a header 501 that defines which TD caused the arrival of the data (in this case the Mth one 415), how much data there is etc. Additional fields may also be stored in the prefix header 501 or in extra bytes at the end of the payload block 502 such as checksums, USB frame number etc.

In this way, the device driver 401 can know the context of the payload data, so that when it later unloads the receive FIFO 406 it can parse the headers and footers and recover the payload that resulted from the transaction and send it to the right destination in the host 418. It should be understood that in the next USB frame, the same sequence would happen again. It should also be understood that the transaction sequencer 407 handles all low-level protocol matters like data encoding, SYNC generation, PIDs, CRC generation and checking and handshaking.

To further extend the usefulness of this autonomous sequencer behaviour, it is advantageous to include in the TD a repeat count, allowing the transaction sequencer 407 to execute each TD up to R times per frame. This way, more USB bandwidth can be used for In-transactions with zero extra overhead for the device driver; if the attached device has more payload data to send then each repeated execution of the TD will yield more data to put into the receive FIFO 406.

Further benefits may be realised by having a special In-Once command that executes exactly once and then self-disables. Further benefits may be realised by having a special In command that can sense when the electronic device 410 returns a “short packet” (one with less than the maximum reported number of payload bytes) and self disables once this is detected. If the In-transaction results in an error, the sequencer will update a TD status field, that the host device driver 401 can inspect to allow appropriate recovery, and the sequencer may elect to self-disable the TD if a serious error has occurred. In this case, no bytes would be written to the receive FIFO 406 and a host interrupt 403 may occur to alert the device driver 401 of the problem.

Secondly, consider an Out-transaction (data requested to flow from host electronic device 418 to electronic device 410).

In this case, the transaction sequencer 407 will inspect the TD 413 and see that its type code is an Out and as such it will need to transmit payload data to a device 410. In order for this to happen, again with consideration that a data-driven architecture is desired, the transaction sequencer 407 will inspect the next available byte of data that is visible at the output of a transmit FIFO 405 (or a dual port RAM or single port RAM with an arbiter). This header byte 504 will have a bit-field 506 that ties it explicitly to a particular TD.

Extending the above example, TD[M] 415 would be inspected by the transaction sequencer 407 and if the type code had been configured by the host device driver 410 as an Out, then the next FIFO byte would also be checked by the transaction sequencer 407 looking for the value M in the bit-field 506. If the value in the byte does not match M, then TD[M] will be skipped and no transaction will occur on the USB for this TD. If the value does match M then the sequencer will know that this payload data needs to be sent using an Out-transaction using the transaction characteristics described in TD[M], such as device address, endpoint etc.

The transmit payload data 503 is prefixed by a header 504, which contains the length of the payload and any other fields to fully define the transmission behaviour. Additionally, a payload footer 505 may contain additional values for use by the sequencer to help control the transmission. The transaction sequencer 407 will attempt to complete the payload block transmission from the FIFO 405.

To improve the usefulness of the host controller 400, the sequencer may also choose to re-execute the same TD again if the field 506 in the next byte from the transmit FIFO 405 that follows immediately after the previous footer, also matches M. In this way several payload blocks can be handled autonomously with zero additional overhead for the host device driver 401. Additionally, to enhance the host controller 400 yet further, the header/footer 504, 505 for a payload block may contain control codes that define whether the sequencer should stop executing the TD after the current payload block. This allows a break in execution of the TD that would otherwise not occur until a block with a header field that did not match M had occurred. This latter enhancement allows the host device driver to accurately split large blocks of data so that they are guaranteed to fit into USB frames, along with any other transactions that may occur in those frames (caused by the other TDs).

Another improvement is to allow the header/footer to cause a status notification to be triggered by the transaction sequencer 407 to the host on detection by the transaction sequencer 407. This is used to mark the end of logical blocks of payload data, for example the end of a complete transfer. In the same way as for In-transactions, the Out-transaction will report its execution status to the host by updating fields within the TD and optionally causing an interrupt request 403 to the host to alert the device driver 401.

One additional feature of note is error handling for Out-transactions. If an Out-transaction should fail to complete, and because the transmit FIFO 405 hardware structure means that reads are destructive, i.e. the payload data can be read only once in a sequential fashion, then the host controller may choose to issue an error context packet 507 into the receive FIFO 405 with header and footer data 508, 509 that the host device driver can use to re-build the transmit payload data from the exact point at which it failed. This allows it to be re-submitted for transmission (i.e. a data retry). In such a case, the transaction sequencer 407 records the presence of this error state for the Out-transaction and continues to process the transmit FIFO in the normal way, as described above. However, because of the error state, the transaction sequencer 407 discards any payload data for TD[M] and does not cause any bus activity. In this was the transaction sequencer 407 flushes payload data for TD[M] beyond the error point.

This mechanism allows host software to retry the payload data from the error point once the flushing operation has finished, this being signalled by polling or by interrupt means.

An alternative approach is to make the transmit FIFO reads non-destructive and employ a method to allow “back-tracking” through the transmit payload block to allow it to be re-transmitted. This latter method requires special consideration for bandwidth usage as the nature of failures is non-deterministic, whereas the sequencer disclosed requires absolute determinism to guarantee that all USB transactions fit inside the fundamental USB frames.

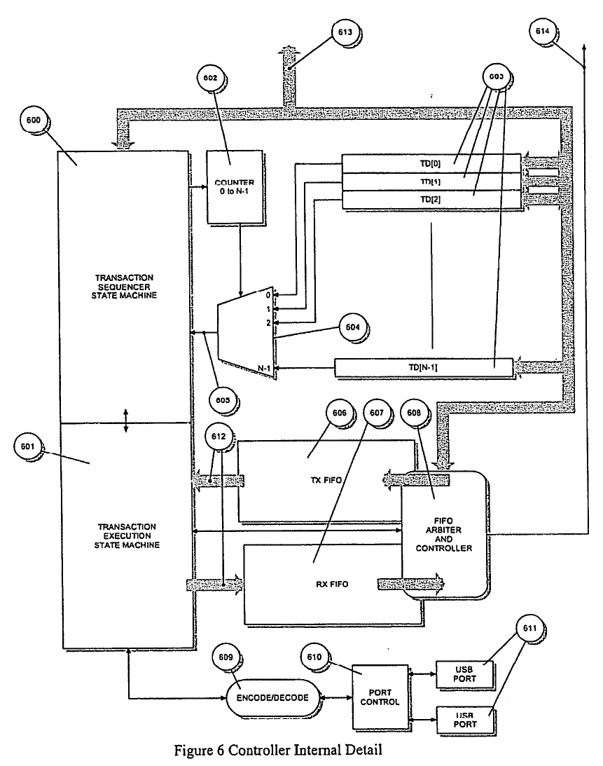

FIG. 6 shows the host controller 400 in greater detail. The host controller 400 comprises two state machines 600, 601 that control the overall operation of the host controller 400. The first is the transaction sequencer 600. This machine controls a simple cyclic counter 602 that is used to select via a multiplexor 604 from a plurality of transaction descriptors 603, the current transaction descriptor 605 to be executed. Each transaction descriptor may be configured via the host using the bus 613 so that its characteristics cause USB activity appropriate to that desired by the host system. These characteristics include a device address, an endpoint address, a transaction type such as In, Out, Setup etc, whether the transaction is an isochronous type etc. These previous terms are explicitly defined in the USB 2.0 Specification and are well known in the art, forming a key part of the USB protocol characteristics.

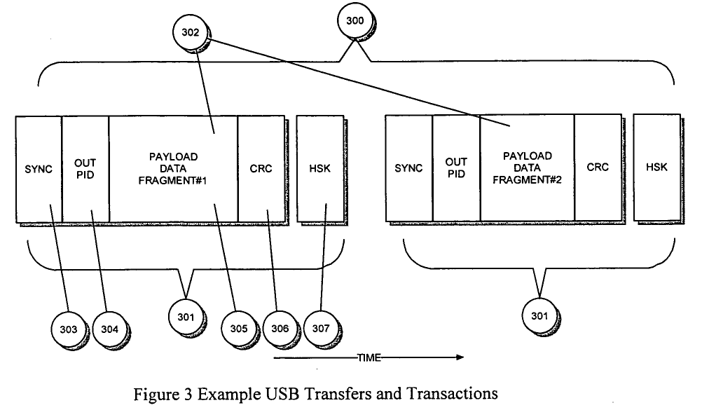

The execution of the current transaction descriptor is controlled using a second state machine called the transaction execution machine 601. This machine handles the internal transaction phases such as SYNC generation, PID token generation, payload data generate or capture, CRC generation and handshaking, all of which phases are disclosed explicitly in the USB 2.0 Specification, and shown in FIG. 3. The transaction execution machine 601 is responsible for delivering or collecting transaction payload data 612 into or from one of the two data FIFOs 606, 607 and uses a FIFO arbiter 608 so that the FIFOs may be used by either this state machine or may be accessed by the host using the connected bus 613. The arbiter 608 ensures that simultaneous access by both parties is avoided, by delaying the access from one side or the other until the other party has concluded its access. These techniques are well known in the art.

The FIFO arbiter 608 is also operable to report the fill or empty status of the two FIFOs 606, 607 to the host and optionally cause an interrupt request to the host 614 to notify it that payload data may be collected or deposited into the FIFOs 606, 607. Finally, the transaction execution machine 601 uses an encoder 609 to convert the transaction phases into electrical pulses suitable to comply with the USB 2.0 Standard. These pulses may be selectively gated using a port controller 610 to allow a plurality of USB ports 611 to receive or transmit said pulses on their USB interface lines, or to block then if the port is to be disabled.

The combination of the above features allows the host controller 400 to operate in a continuous manner, cycling around the transaction descriptors and conditionally executing them based on whether they are each enabled, or whether there is payload data associated with them. In conventional host controllers, the execution of transactions is often discontinuous and happens in batches, requiring the host to submit further lists of transactions on a periodic basis. The operation of the host controller of the present invention differs fundamentally in that it runs continuously and requires only payload data to be loaded or collected in batches. This means that the logic required to implement the various host controller state machines can be simplified, because the sequencing of each transaction descriptor is effectively hard-wired.

Another advantage of the present invention can be seen with In type USB transactions. Due to the cyclic nature of the host controller, one or more In-transactions can be programmed to happen every USB frame with no host intervention. Each time the In-transaction executes, more payload data may flow into the RX FIFO 607 until eventually the host will receive notification that a certain fill level in the FIFO has been reached or passed, allowing the host to collect the said payload data using an efficient block data copy from the RX FIFO into host system memory, whereupon it is then presented to the appropriate destination address in the host (as requested by some USB client device driver). This allows for very efficient USB bandwidth utilisation with no additional host intervention required to repeatedly configure or adjust the transaction descriptor characteristics.

In a similar way, an advantage is also seen with Out or Setup type transactions. Here again, once a transaction descriptor is configured by the host, it will execute every frame due to the cyclic nature of the host controller state machine. The host merely has to deposit more payload data into the TX FIFO 608 when it receives notification that sufficient FIFO space is available to cause said data to be transmitted, and the host does not have to repeatedly configure or adjust the transaction descriptor characteristics.

The above devices and techniques may be used with various types of USB transaction involving data transmission between the host and device in either direction, and it should be understood that In and Out have been used only by way of example. The USB standard defines each type of transaction that may occur and that must therefore be built into the transaction sequencer 407 of such a host controller.

With the above methods for transmit and receive, it can be seen that the two FIFOs 405, 406 employed can be made to signal their fill or empty states 416, so alerting the host device driver 401 that more payload data is available in the host controller's memory or can be deposited into the host controller's memory.

It should be noted that the fill status signalling 416 may be via an interrupt request 403 or by the host device driver polling the host controller's status using the system bus 402. The host device driver can additionally read the host controller's status via the bus 402 to see how much payload data or free space there is in the two FIFOs and act appropriately, so optimising the usage of the bus 402 by performing efficient block data moves at high speed. It should also be noted that an implementation using a single memory to handle transmit and receive is possible, using a suitable arbiter or memory controller to allow each direction to function independently of the other.

It should further be understood that in the accompanying Figures, the new host controller is shown directly attached to the system bus 402, but the same architecture can equally be used if there is one or more bus-bridging or bus-translation devices in series between the host system 418 and the USB host controller 400. One such example of a bridge 417 is shown in FIG. 4.

It should be further understood that the technique described herein is generally applicable to host controllers implementing protocols other than USB, that similarly require scheduling of data and that need connection to a system or expansion bus that has no bus mastering or DMA bus access methods. Where these other bus protocols organise bus traffic using transfer structures with simpler sub-divisions of the transfers into transactions, then the disclosed simplified host controller architecture may advantageously be used to effect simpler and lower cost host controller devices for such a bus.

The embodiment described above discloses a slave-only data-driven USB host controller that allows a simple and efficient transaction sequenced method to be used to generate USB traffic, so avoiding the need for bus mastering, DMA or for complex transfer based host controller sequencing methods as disclosed in conventional devices. This allows the host controller to be implemented using less logic and hence using less space and less power. More of the transfer and transaction scheduling responsibility is placed on the host device driver allowing greater flexibility and cost savings to be realised.

Although the invention has been described in relation to the preceding example embodiment, it will be readily understood by those of ordinary skill in the art that many different embodiments employing the inventive concepts of the invention are possible. For example, those skilled in the art will be aware that the sequence of transaction descriptors may be hard-encoded into the first memory device, for example, using firmware or hardware. Those skilled in the art will also be aware that the first and second memory devices could be provided by the same or different memory devices, and that such memory devices could, for example, be implemented using a single port RAM device with an arbiter, dual port RAM, etc. Additionally, various embodiments of the invention will be apparent which may be implemented using hardware, firmware or software, or various combinations thereof. Various embodiments using a pure slave architecture will also be apparent, as well as various embodiments that can combine the use of DMA or bus mastering techniques as may be required for any particular application.

Various applications for the present invention are also envisaged. For example, embodiments of the present invention may be particularly useful in devices having proprietary bus structures or where there is constrained bus bandwidth. Many applications are envisaged in which the present invention can be usefully employed, for example, in: personal computer (PC) cards, Compact Flash cards, memory stick devices, set-top boxes for satellite TV or Internet access etc., peripheral devices such as printers etc., embedded USB applications, personal digital assistants (PDAs), mobile communications devices such as mobile telephones, PCMCIA cards, Express Cards, etc.

### REFERENCES

1. WO2004/102406
2. US 2002/0116565

What is claimed is:

1. A host controller for interfacing one or more electronic devices to at least one packet-based timeshared bus, the host controller comprising:
a first memory device storing a sequence comprising a predetermined number of transaction descriptors;
a second memory device operable to store payload data transmitted over at least one packet-based timeshare bus; and
a transaction sequencer operable cyclically to execute transactions defined by the transaction descriptors stored in the first memory device so as to obtain payload data for storage in the second memory device.

2. The host controller of claim 1, wherein the second memory is a first-in first-out (FIFO) memory device.

3. The host controller of claim 2, further operable to transmit payload data in the second memory with a transaction descriptor by way of extra data stored in the FIFO memory along with the payload data, wherein said extra data is arranged to immediately precede or immediately follow the payload data.

4. The host controller of claim 1, further operable to identify a transmission error and to cause a temporary cessation of transmission or reception of any payload data matching the transaction descriptor that generated the transmission error.

5. The host controller of claim 1, further operable to:
detect when the second memory contains a predetermined amount of payload data; and
generate a notification signal for initiating an electronic device to deposit data to the second memory or collect payload data from the second memory.

6. The host controller of claim 1, wherein the transaction sequencer is operable identify transactions as being disabled and to skip the processing of such transactions.

7. The host controller of claim 1, wherein at least one said packet-based timeshared bus is a universal serial bus (USB).

8. The host controller of claim 1, wherein the first memory device stores 8 to 32 predetermined transaction descriptors.

9. The host controller of claim 1, wherein the transactions comprise a plurality of transaction types, and the host controller is operable to execute each transaction having regard to its transaction type.

10. The host controller of claim 9, wherein one of the transaction types is defined so that a transaction of this type is executed only once and then self disables.

11. The host controller of claim 9, wherein one of the transaction types is defined so that a transaction of this type is executed a plurality of times per host controller cycle.

12. The host controller of claim 9, wherein one of the transaction types is defined so that a transaction of this type is executed repetitively but with a frequency reduced to once every two or more host controller cycles.

13. The host controller of claim 9, wherein one of the transaction types is defined so that a transaction of this type is executed in dependence upon availability of payload data for that transaction.

14. The host controller of claim 1, wherein the first and second memory devices are provided by the same hardware or firmware device.

15. An apparatus comprising:
at least one electronic device;
at least one packet-based timeshared bus; and
a host controller interfacing the at least one electronic device to the at least one packet-based timeshared bus the host controller comprising:
a first memory device storing a sequence comprising a predetermined number of transaction descriptors;
a second memory device operable to store payload data transmitted over at least one packet-based timeshare bus; and
a transaction sequencer operable cyclically to execute transactions defined by the transaction descriptors stored in the first memory device so as to obtain payload data for storage in the second memory device.

16. The apparatus of claim 15, wherein the electronic devices include at least one of: a memory controller, a wired communications controller, a wireless communications controller, a disk controller, an RFID controller, an optical communications controller, a GPS receiver, a TV receiver, a radio receiver, a human interface device controller, a display controller, and an audio controller.

17. The apparatus of claim 15, wherein the apparatus is one of: a personal computer (PC) card, a Compact Flash card, a memory stick device, a set-top box, a peripheral device, a personal digital assistant (PDA), a mobile communications device, a PCMCIA card or Express Card, and a notebook or tablet computer.

18. A method for controlling data transfer of payload data, comprising:
providing at least one packet-based timeshared bus to which one or more electronic devices are connected;
cyclically executing transactions respectively defined by a sequence comprising a predetermined number of transaction descriptors stored in a host controller; and
storing the payload data in the host controller.

19. The method of claim 18, wherein storing of the payload data comprises storing the payload data in a first-in first-out (FIFO) memory device.

20. The method of claim 18, further comprising transmitting extra data with the payload data, wherein said extra data is arranged to immediately precede or immediately follow the payload data.

21. The method of claim 18, further comprising identifying a transmission error and causing a temporary cessation of transmission or reception of any payload data corresponding to the transaction descriptor that generated the transmission error.

22. The method of claim 18, further comprising:
detecting when the amount of payload data stored in the host controller contains a predetermined amount of payload data;
generating a notification signal for initiating a host electronic device to deposit the payload data to the host controller or to collect the payload data from the host controller; and
transferring the payload data to or from respective one or more electronic devices.

23. The method of claim 18, further comprising:
identifying transactions that are to be disabled; and
skipping the processing of any such transactions that are to be disabled.

24. The method of claim 18, wherein at least one said packet-based timeshared bus is a universal serial bus (USB).

25. The method of claim 18, further comprising providing 8 to 32 predetermined transaction descriptors in the host controller.

26. The method of claim 18, wherein the transactions comprise a plurality of transaction types, and the host controller identifies the transaction type of each transaction as it is executed.

27. The method of claim 26, further comprising:
identifying a transaction of a type that is to be executed only once;
executing that transaction only once.

28. The method of claim 26, further comprising:
identifying a transaction of a type that is to be executed a finite plurality of times per host controller cycle; and
executing that transaction a finite plurality of times per host controller cycle.

29. The method of claim 26, further comprising:
identifying a transaction of a type that is to be repeatedly executed at reduced frequency; and
repeatedly executing that transaction at the reduced frequency.

30. The method of claim 26, further comprising:
identifying a transaction of a type that is to be executed conditional on availability of payload data; and
executing that transaction conditional on the availability of the payload data for that transaction.
